(19) United States
(12) Patent Application Publication
(10) Pub. No.: US 2007/0190095 A1
(43) Pub. Date: Aug. 16, 2007

(54) Coffee and its derivatives as an animal repellent composition and its use in a molluscicide bait

(76) Inventor: Debrah Miller Emerson, Bow, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/653,653

(22) Filed: Jan. 16, 2007

Related U.S. Application Data
(60) Provisional application No. 60/759,931, filed on Jan. 19, 2006.

(51) Int. Cl. A01N 65/00; A01N 25/00

(52) U.S. Cl. 424/405; 424/776

(57) ABSTRACT

An animal repellent composition containing coffee and or its derivatives. This composition may be used alone or in conjunction with molluscicidal co-active agents and/or fertilizers.

### CROSS REFERENCE TO RELATED PUBLICATIONS

This application is based on and claims priority from U.S. provisional patent No. 60/759,931, filed on Jan. 19, 2006.

### STATEMENT REGARDING FEDERALLY SPONSORED RESEARCH

Not Applicable

### FIELD OF THE INVENTION

This invention relates to a natural occurring substance as it can be used in a composition as an animal repellent, and more particularly, in composition with molluscicides to prevent animals from ingesting the poisons, and/or in composition with fertilizers for agricultural or horticultural use.

### BACKGROUND OF THE INVENTION

For many years I have been using coffee grounds or fresh ground coffee to keep dogs and cats from laying and digging in the garden beds of my home and my clients gardens, and it has worked very effectively. I learned this from my uncle who discovered it while feeding coffee grounds to the earth worms he farmed for fishing. The ground coffee or leftover coffee grounds were sprinkled over the garden at approximately 1 cup per 40 square feet. Then to keep pulmonata (land slugs and snails) from damaging the plants a molluscicide with metaldehyde was sprinkled over the garden in approximately the same proportions. It occurred to me that coffee could be added to a molluscicide to not only save a step in the process, but to protect the animals from ingesting the molluscicide which is deadly to them as well as pulmonata. Coffee could also be substituted for some of the fillers and/or attractants in mollescicides as its oils are long lasting and hold up in the weather.

Coffee is “generally recognized as safe” by the Federal Government and in these quantities is harmless to plants and the soil. And even though coffee and its derivatives repel cats and dogs and possibly undomesticated animals, it smells pleasing to most humans.

Caffeine, an element found in coffee, is a xanthtine alkaloid compound. Caffeine is sometimes called guaranine when found in guarana, mateine when found in mate and theine when found in tea. Caffeine is found in over 60 plants where it acts as a natural pesticide that paralyzes and kills certain insects when feeding on them. This in itself could be beneficial when incorporated in a molluscicide to eliminate some of the insects as well as pulmonata.

Research done by Robert G. Hollingsworth, a research biologist with the U.S. Pacific Basin Agricultural Center in Hilo, Hi., found that a 2% solution of caffeine in water sprayed on the coconut husk-chip material in which orchids are grown killed 95% of the snails present. This would be an added benefit, but my experimentation showed that coffee and its caffeine didn't detour pulmonata at all.

As pointed out in U.S. Pat. No. 6,532,706 (Puritch), molluscicides fall in two groups, namely contact poisons or ingested poisons. One of the few compounds that acts as both a contact and ingested poison is metaldehyde. It also states “despite its high effectiveness and its commercial popularity, metaldehyde is toxic to higher mammals and is a major contributor to domestic animal poisoning in the U.S. and Europe.” Coffee could be added to molescicides containing metaldehyde, or any other mollescicide, to repel animals before they had a chance to ingest the poison.

U.S. Pat. No. 4,940,583 (Thompson) also points out that the frequency of occurrences of dogs consuming in particular toxic molluscicides is quite high and it states that in New Zealand the government legislation requires that an animal repellent be included in all metaldehyde based pellet baits. It discusses various repellents for mammals that already exist in the prior art, including denatonium benzonate (a bittering agent), capsaicinoids (mucous membrane irritants), or various proprietary mixtures of essential oils. In the first two a potentially lethal dose of metaldehyde could be consumed by an animal before the animal realized that the pellets were unpalatable. Further, the aforementioned repellents are extremely unpleasant to handle during manufacturing. “Other compositions based on ketones, particularly those containing methyinonyl ketone show poor stability in use owing to the decomposition.” Also some essential oil compositions, while acting as a dog repellent will also repel pulmonata to the extent that the pulmonata receive a sub-lethal dose of poison. Thompson's invention suggests using ipecacuanha extract (a powerful emetic used in syrup of ipecac) in composition with the metaldehyde. This would not repel animals, but would cause them to trow up if the composition was eaten.

U.S. Pat. No. 6,277,889 (Bowen) suggests using Metha puleglum as a bird and animal repellent, but in my gardening experience dogs don't mind this type of mint cats are fond of it.

Coffee and its derivatives would make a preferable component in mollescicides to any of the previous inventions as it repels animals, in most cases keeping them out of the gardens altogether, it doesn't repel the pulmonata so they will ingest a lethal dose, it is harmless to animals and the environment, it is long lasting in the weather, it is easily processed, cost effective and it is not offensive to most humans.

### SUMMERY OF THE INVENTION

This invention uses coffee and or its derivatives in combination with a carrier material or other formula enhancing additives as an animal repellent. It also uses coffee and or its derivatives as an additive to any molluscicide to make the product safe for use around animals, preventing their ingestion while encouraging its ingestion by pulmonata (land slugs and snails), keeping animals and pulmonata from damaging gardens and crops. It also uses coffee and or its derivatives as an additive to fertilizers to repel animals. And this invention also uses coffee and or its derivatives in combination with molluscisides and fertilizers to repel animals, keeping them from ingesting the product or damaging the crops, while it kills pulmonata, and fertilizes crops, simplifying. the gardening process.

### DETAILED DESCRIPTION OF THE INVENTION

This invention provides a composition that acts as an animal repellent. In one embodiment the composition includes coffee and/or its derivatives in combination with any molluscicide to prevent animals from ingesting the poisons. In a second embodiment coffee and/or its derivatives are combined with a powdered or granular form of fertilizer to repel animals in the garden. In a third embodiment coffee and/or its derivatives are combined with a mollescicide and a fertilizer to simplify the gardening process by feeding the crops, killing pulmonata and keeping animals out of the area, preventing their poisoning and preventing damage to crops.

The following examples serve to illustrate this invention.

### EXAMPLE ONE

To determine if coffee and its caffeine would kill pulmonata; as suggested by the article by Marion Owen stating that testing done by Robert Hollingsworth of the U.S. Department ofAgriculture in Hilo, Hi. found that a caffeine solution of 2% with water killed 95% of the snails when sprayed on the coconut husk planting material; a group of 3 Star Gazer Lilies with 7 random slugs visible on them was sprayed with ¼th strength brewed coffee. This coffee was made by drip method of 5 and ½ cups water through ½ cup ground Uban coffee and was at room temperature. None of the slugs moved at all. Fifteen minutes later the slugs on the lilies were sprayed with the full strength cooled coffee. some of the slugs moved a short distance but none of them left the plants and none of them died. This showing that brewed coffee by itself would not detour slugs. Previous experience of putting roasted ground coffee or grounds of brewed coffee on my garden beds to repel our pets also showed that pulmonata were not detoured by coffee or its amount of caffeine.

### EXAMPLE TWO

To determine if roasted coffee would repel cats and dogs in the general population a test was done at the animal shelter in Skagit Valley. The test was done between 11:00 a.m. and 1:30 p.m. The animals had just been feed at 11:00 a.m. so they weren't hungry. The test included 33 cats and 44 dogs. First ½ cup of ground coffee was put in a small frying pan and held in front of each cage for approximately one minute to see if the animal would approach the pan (showing interest). Five of the 33 cats came to see what was in the pan and 22 of the 44 dogs showed interest. Then the pan was cleaned with soap and water and ½ cup of Corey's slug bait meal was put in the pan and presented to the animals in the same manner. Ten of the 33 cats and 32 of the 44 dogs came forward to inspect the pan with the slug bait in it. The animals showed significantly less interest in the coffee than the slug bait.

### EXAMPLE THREE

This experiment was designed to be a more natural setting. A composition of ½ cup Corey's slug bait and ½ cup ground roasted coffee was used as the test material. Five members of the Edgewater Garden Club and myself did a test in our own gardens. The test material was spread over an area approximately 32 square feet. A comparison area of approximate size using no mollescicides or repellents was also used for observation. Both areas were accessible to animals. For two weeks we recorded our observations each morning and evening as to the weather conditions, any pulmonata slime trails, dead pulmonata, damaged plants, animal tracks or other signs that animals had been digging or laying in the test areas.

Mrs. Goodan and I started our tests on Mar. 11, 2006. The weather temperatures were between 38 and 48 degrees in the day with some sun and rain. There was no sign of pulmonata in either the test area or the control area of my garden and our cat had tracked through the control area 3 different times and tracked through the test area once on the fifth day. Mrs. Goodan reported “holes in the leaves in both the test area and the control area at the beginning of the test, and no sign of disturbance in either area for the rest of the two weeks.

Mrs. Gauaham and Mrs. Michel started their tests the end of March. The weather was mostly overcast and damp, perfect conditions for pulmonata. Mrs. Gauaham had just put down a heavy bark mulch in both areas. She reported sign of pulmonata in the test area on the second day, but no other sign of animals or pulmonata. After 9 days she quit observing.

Mrs. Michel did her testing in an area that was previously planted with Japanese Butterbun witch is very attractive to pulmonata. She used the test material on one side and used the other side for the control area. She reported lots of dead slugs the first week in the test area and little activity the second week. The control area had many slugs and much damage. She saw no sign of animals in either area, but reported a few birds in the control area.

Mrs. Hopley began her test on May 17, 2006, but only tested for 6 days saying she quit because of rain. She reported lots of slugs and damage and continuous cat tracks in the control area. In the test area she reported lots of dead slugs and only one sign of the cat which actually took a nap in the test area. (The test material may have lost some of its sent from being stored for over 2 months in a plastic baggie.)

Mrs. Chatham reported back on Jun. 15, 2006 saying that she lost the paperwork, but that the test material seemed to work for her and she wanted to buy some.

### EXAMPLE FOUR

Mrs. Polly, a design client of mine, did a test using a fresh sample of the same formulation of ½ cup Corey's slug bait and ½ cup ground roasted coffee. She has two large dogs and had recently planted a new landscape. Her test was done in mid July. She reported that she had put the bait/repellent sample on the new lawn. Immediately Lucy (the young dog) quit using the lawn for her bathroom and started using another area that she previously used for sleeping. Aretha (the old dog) seemed unaffected and continued to go on the lawn. (Aretha's sense of smell may have been diminished due to her age.)

### EXAMPLE FIVE

A final test was done with my daughter's 6 month old dog who eats anything she finds including soap she found on the shower floor. While we were making lunch she was offered a plate with ground coffee on it. she smelled it but walked away. This was the first food I have observed her to turn down.

There was no further testing done with the formulation of coffee and metaldehyde as metaldehyde can only be purchased from Lonza Inc. in 16 ton tanker loads.

Having described the preferred embodiments of the invention, it will be apparent to one of ordinary skill in the art that other embodiments incorporating their concepts may be used. It is believed, therefore, that these embodiments should not be limited to disclosed embodiments but rather should be limited only by the spirit and scope of the appended claims.

What is claimed is:

12. An animal repellent formula containing coffee and/or its derivatives.

13. The formula of claim 12, further comprising a non-toxic distributing material such as, but not limited to, wood pulp or grain.

14. The formula of claim 12, in combination with a molluscicide.

15. The formula of claim 14, wherein the molluscicide comprises metaldehyde.

16. The formula of claim 15, wherein the metaldehyde is present at a concentration of not more than about 6 wt/wt % of the total weight.

17. A molluscicide formulation containing coffee and/or any of its derivatives, arranged as an attractant to pulmonata (land slugs and snails).

18. The molluscicide formulation of claim 17, in combination with a granular or powdered fertilizer.

19. The molluscicide formulation of claim 17, further comprising powdered or granulated fertilizer, with the molluscicide containing metaldehyde.

20. The molluscicide formulation as claimed in claim 19, wherein the metaldehyde is present at a concentration of not more than 6 wt/wt %.

21. The molluscicide formulation of claim 17, in combination with iron phosphate.

22. The molluscicide formulation of claim 17, in combination with copper sulphate.

23. The molluscicide formulation of claim 17, in combination with methiocarb.

24. A formulation combining coffee and/or its derivatives with a fertilizer and a molluscicide containing one or more of iron phosphate, copper sulphate, methiocarb and/or any combination of these.
